(19) United States
(12) Patent Application Publication
(10) Pub. No.: US 2008/0115437 A1
(43) Pub. Date: May 22, 2008

(54) Plastic resin based composite tile board article and associated method for creating through routing and/or embossing of a substantially upper most layer thereof in order to create a decorative pattern

(76) Inventor: Robert Bordener, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/562,158

(22) Filed: Nov. 21, 2006

(51) Int. Cl. E04F 13/08; B29C 47/08

(52) U.S. Cl. 52/311.1; 425/461; 156/244.11

(57) ABSTRACT

A material, system for generating and associated method for producing of a composite, resin based and waterproof article exhibiting a faux tile board appearance. The tile board material is produced according to a co-extruding or co-laminating process and in order to include at least a top layer and a backer layer, one or more of which is substantially opaque and includes a decorative component mimicking at least one of a metallic, glass graphic or stone appearance. Either or both of a heat embossing component or a mechanical and numerically controlled router is employed to create a plurality of intersecting grid lines having a roughened, matte finish which mimics that of grout lines separating tile surfaces.

### BACKGROUND OF THE INVENTION

1. Field of the Invention

The present invention relates generally to decorative tile systems, as are well known in the field of construction. More specifically, the present invention discloses a three-dimensional thermoset composite article exhibiting a faux tile board appearance which is capable of creating a realistic appearance of a surrounding grout system, substantially nonporous and without the requirement for any additional sealing steps.

2. Description of the Prior Art

The original “wet set” tile process involved placing conventionally known ceramic tiles directly into a site-mixed mud backing that bound the tiles with lime. This is literally an ancient process and it is rarely used today, in all but the most expensive installations. A process improvement of that system came with a “thin set” veneer mud material and system that was used popularly from about 1970 through the 1990s. That process employs the improved step of a separate lime/mud [thin set] layer being applied over the already cured traditional site-mixed mud base layer. This allows construction to proceed without the delicate tiles in place where they might get scratched or damaged. More importantly, this also allows for less skill required by the tile mason to correctly set the tiles, and since a flat base can be achieved in the mud base and an even tile pattern could be developed separately, rather than having to do both at once.

The breakdown of earlier formal training and apprenticeship programs has affected tile masonry as much as any trade. Further reductions in required technical skill were demanded by the market and the next development came in the form of pre-cast composite concrete board sold under the trade names Durock® and WonderBoard®, among others. These innovative materials allowed the most difficult skill remaining in the tiling process to be eliminated—the mixing and installation of the flat mud base. This innovation allowed for much reduced skill level requirement to be necessary for the installation of water-resistant tile systems.

The latest innovation in tile systems includes the provision of etched thermoplastic and thermoset tile systems, as disclosed in Gentscli et al., U.S. Pat. No. 5,052,160. In particular, Gentsch teaches a tile board made from a one-piece sheet having top and bottom portions of contrasting colors. Grooves are machined through the top layer to expose strips of the bottom layer. The exposed strip divides the top layer into tile size members which simulate inlaid tiles having beveled edges. The exposed strips of the bottom layers simulate recessed grout lines. Machining of the grooves through the top layer simultaneously forms the simulated tiles and simulated grout lines in the plastic sheet. The tile board can exhibit a bent edge section to provide a finished tile look spanning a corner of two adjacent walls.

The Gentsch disclosure therefore generally represents the ability to prefabricate a mud [plastic] base and tile, all in one panel and which is capable of being pre-installed as a single component, thereby nearly eliminating the need for specialized labor. Furthermore, and while this most recent prior innovation was successful in terms of elimination of installation cost and skilled labor components, the material itself creates only a passing resemblance to site-set tiles systems of the prior art.

Furthermore, and wherein the prior improvements all were not differentiable from higher complexity earlier systems, this innovation fell short in aesthetics. The process of routing a simple groove into a 2-layer panel to simulate a grout line has been determined to result in a flat planar square, this only partially resembling a piece of ceramic tile.

What is needed in the prior art is an improved tile panel system that captures all of the economic advantages of prior art panelized systems, such as in Gentsch, however provides a more realistic tile appearance. A further benefit would be achieved if the tiles themselves could have desirable decorative effects beyond what is available in ceramic tiles, and so as to provide a further competitive advantage to these materials.

### SUMMARY OF THE PRESENT INVENTION

The present invention teaches a material, system for generating and associated method for producing of a composite, resin based and waterproof article exhibiting a faux tile board appearance. The tile board material is produced according to a co-extruding or co-laminating process and in order to include at least a top layer and a backer layer, one or more of which is substantially opaque and includes a decorative component mimicking at least one of a metallic. glass, graphic or stone appearance.

Either or both of a heat embossing component or a mechanical and numerically controlled router is employed to create a plurality of intersecting grid lines, further preferably having a roughened, matte finish which mimics that of grout lines separating tile surfaces. An optional top coat surface, such as which usually exhibits a high gloss scratch-resistant material, can also be applied by either a further co-extruding or co-laminating process, typically prior to a surface routing operation and in order that the grout exhibit a matte finish while the tiles exhibit a glossy surface.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective environmental view of a plastic resin-based composite tile board according to a preferred embodiment of the present invention;

FIG. 2 is a side plan view of the tile board according to claim 1 and further illustrating the raised/embossed nature of the faux tile grout edges according to a preferred embodiment;

FIG. 3A is a schematic illustration of a first selected manufacturing process according to the present invention and by which a selectively co-extruded or co-laminated top decorative layer is applied upon a co-extruded substratum sheet;

FIG. 3B is a further schematic illustration of a further selected and modified manufacturing process and by which a heat embossment step is applied to the upper co-extruded layer and in order to create the faux tile appearance by forming rounded edges associated with each faux tile; and

FIG. 4 is a further isometric view illustrating the three-dimensional nature of te faux tile resin composite according to the present invention.

### DETAILED DESCRIPTION OF THE PREFERRED EMBODIMENTS

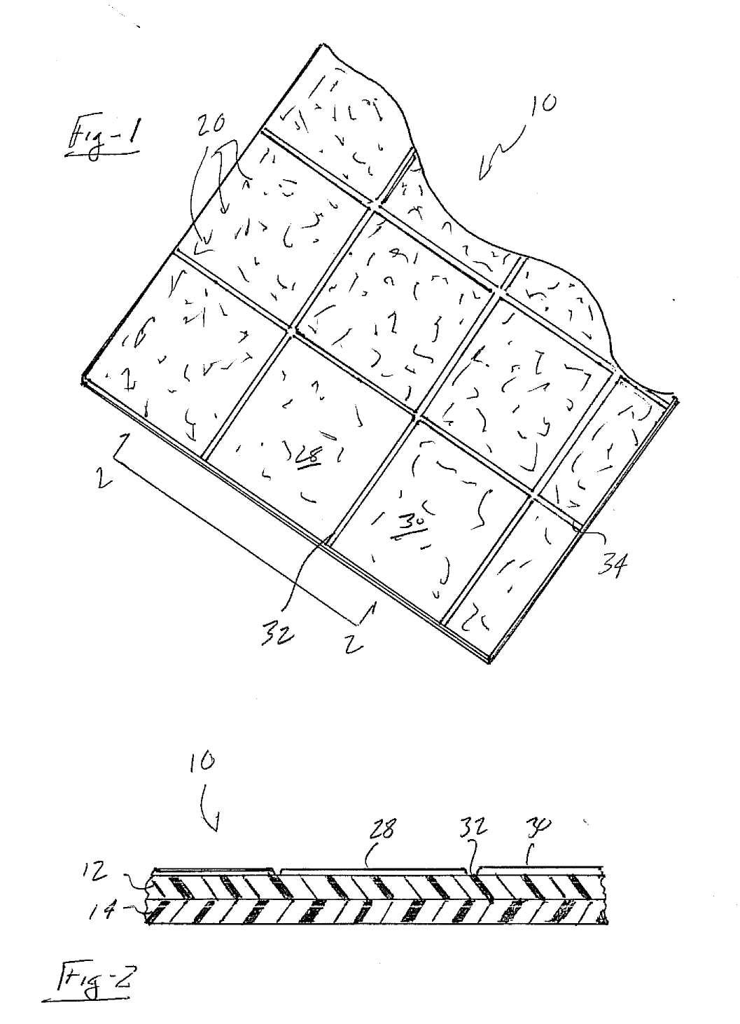

Referring now to the drawings, and in particular to FIG. 1, the present invention discloses a composite material 10 exhibiting a decorative faux tile board appearance. In particular, the present invention is an improvement over prior art tile board designs, both real and faux appearing, particularly in that it provides a resin based and fully waterproof article with a lifelike ceramic tile appearance and which is suitable for application to such as a number of different substrate materials.

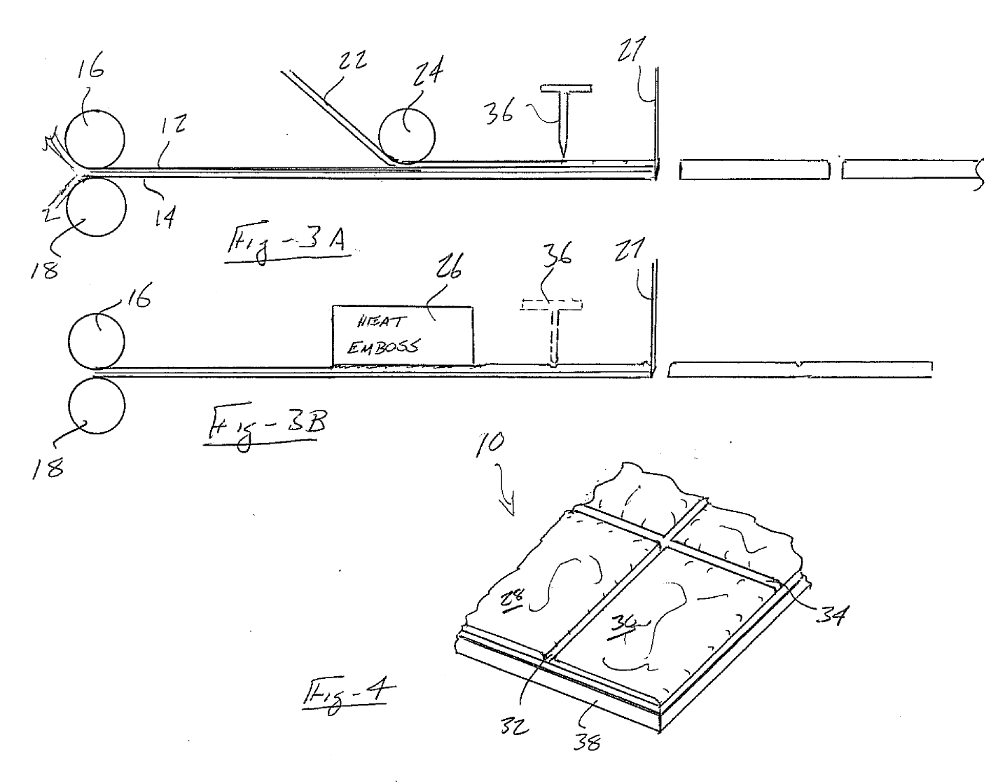

As will also be illustrated with successive reference to FIGS. 2, 3A, 3B and 4, the sheet material is preferably co-extruded, however it may also be co-laminated or formed in an otherwise fashion within the scope of the present invention. In particular, the composite material includes a top layer 12 and a backing layer 14, these including being co-extruded as shown in FIG. 3A and as represented by rollers 16 and 18.

In a preferred embodiment, an ideal polymer system utilizes a polyolefin such as polypropylene, and particularly if the inputted resin, such as in pellet or ingot form (not shown) can be at least partially cross-linked after the resin is introduced into the extruder, and as is further known in the art. At least one of the co-extruded layers, and typically the backer layer 14, is substantially opaque in appearance, a corresponding top layer 12 also potentially including at least a partially opaque appearance with a decorative particulate and index-of-refraction matching material, see as referenced at 20 (in FIG. 1), such in particular with a mean size distribution of less than 0.008″ therein. The index of refraction, these being measured in wavelengths relative to ^{η}D, denoting yellow sodium light, is exhibited by a matching material within 0.3 ^{η}D.

In a further variant, the substantially opaque top decorative layer exhibits a clear film overlay (see at 22 in FIG. 5A and as applied by roller 24 generally representing a secondary co-extruding process). The clear, uppermost layer 22 provides high gloss, additional UV resistance, and extreme scratch-mar resistance and may additionally be provided in a co-laminating process and along with which may be contaminated any suitable thermoplastic or thermoset resin or cellulosic material layer.

A yet another variant of the opaque upper decorative layer configuration involves a further inventive step of heat embossing the upper layer, see as shown at 26 in FIG. 3B, and in order to form a plurality of soft rounded edges associated with each individual tile. Reference is made to both the side view of FIG. 2 as well as the additional perspective illustration 10 of FIG. 4 by which selected tile defining surfaces 28, 30 et seq. are separated by an interconnecting grid of grout lines, further represented at 32, 34, et seq. and providing the article created with rounded edges between the simulated tile and grout edges, this creating a more realistic faux ceramic appearance. Additional layers of material may be applied (e.g. by co-extruding, co-laminating or the like) and can include a polyolefin material, an ABS/Acrylic, or any combination thereof, a cellulosic material, a thermoset material or the like.

It is further envisioned that the article thus created may then optionally be routed to further simulate grout lines, reference being made to router 36 in FIG. 3A and such as which may be precisely directed by a numerically controlled machine (not shown). It should again be noted that the grout lines may also be simulated by the heat embossing process 26 (again FIG. 3B) this presenting a matte finish in the area representing the grout lines. As also again shown in FIG. 3B, the use of a routing tool 36 may follow an initial heat embossment step 26 within the scope of the invention.

Additional roughening of the top surface, such as through sanding, abrading or the like, will further serve to remove an otherwise glossy “sheen” appearance which results from embossing, this providing a more “lifelike appearance of stone and other materials”. Further, the ability to have a renewable mechanical matte finish greatly increases the field durability of such a material. Additional incorporation of high aspect ratio granules (i.e. those defining an average length or width typically two times or more greater than an average thickness) into such as a top or upper layer of a two layer tile board article, including an opaque consistency backer layer, provides a more attractive and visually effecting article, and the further incorporation of higher aspect ratios avoids the undesirable instance of flow lines in the resultant article.

The present invention thus creates a fully realistic three-dimensional ceramic tile-appearing component, set within a very realistic grout system that can be made 100% non-porous and does not need a further sealing step, such as is otherwise required in the process of routing existing thermoset panel faux tile boards. This entails saving a process step, thus reducing cost and avoiding the introduction of additional and undesirable emissions into the environment.

Further, the present invention is thermoformable, can be trimmed with a razor knife, see at 27 in FIGS. 3A and 3B, and is 100% waterproof (unlike ceramic based components), thereby further eliminating the need for any mud backer. The article 10 according to the present invention can be applied to any sort of substratum material, see at 38 in FIG. 4, including such as foam, drywall, wood, metal, other plastics. Further still, and especially for solid colors used to simulate ceramic tile, the tile faces themselves can be made with a durable high-gloss surface that convincingly represents the appearance of site-set ceramic tiles.

Moving beyond conventional tile appearances, where the plastics composites art has thus far previously confined all of its efforts, the present invention provides for new appearance types not available on any products on the market and not taught anywhere in the art. These effects include a metallic appearance, a glass appearance, a graphics appearance, and a stone appearance (e.g. Corian® or other like material).

With the innovative steps of substituting a clear/translucent upper layer to contain three-dimensional decorative effects, the tiles themselves can exhibit improved appearance options. Further, and as previously described the step of hot embossing a tile pattern onto the upper layer of the co-extruded/co-laminated sheet assists in creating the soft rounded edges mimicking those of real tiles, this providing a very convincing visual effect.

The simulation of grout separation is furthered achieved by routing of groove lines into the center of the embossing lines, further preferably these grooves being routed into a non-porous plastic, with low oil and water absorption values, thereby eliminating the need for a secondary sealing spray coating. According to additional high-gloss applications, a high gloss film can be applied to the panel, preferably prior to the routing and embossing steps, and so the grout will exhibit a matte finish such as in an actual ceramic based material, the tile edges maintaining a glossy appearance like the tile faces.

Having described my invention, other and additional preferred embodiments will become apparent to those skilled in the art to which it pertains, and without deviating from the scope of the appended claims.

I claim:

1. A composite material exhibiting a decorative faux tile board appearance, comprising:
a co-extruded article including at least a top layer and an adhering backer layer exhibiting a specified length, width and thickness;
at least one of said layers being opaque layer;
at least one of said layers further incorporating a decorative component;
said decorative component selected from at least one of a granite, metal, and glass effecting material; and
piercing at least one upper layer to expose at least a portion of a succeeding lower layer to create a faux tile board appearance.

2. The material as described in claim 1, said article exhibiting an embossed upper surface replicating a series of contoured tile edges along both sides of each linear piercing of the upper layer, thereby simulating a three-dimensional tile appearance by creating interconnecting grout lines, between which are defined individual tiles.

3. The material as described in claim 2, said three-dimensional faux tile article exhibiting a specified shape and size and providing a substantially monochromatic effect.

4. The material as described in claim 3, said article exhibiting a specified shape and size and further comprising a durable, substantially clear and high-gloss overlaying surface.

5. The material as described in claim 1, at least one layer of said article further comprising a polyolefin resin material.

6. The material as described in claim 2, said embossed upper surface further comprising a plurality of rounded edges established between said tiles and grout lines.

7. The material as described in claim 1, further comprising said backer layer exhibiting a substantially opaque appearance, said top layer further exhibiting at least a partially opaque appearance and further including a decorative particulate exhibiting an index-of-refraction matching material within 0.3 ^{η}D with a mean size distribution of less than 0.008″ therein.

8. A system for generating a composite material exhibiting a decorative faux tile board appearance, comprising:
an extruder for generating a co-extruded article including at least a top layer and an adhering backer layer collectively exhibiting a specified length, width and thickness, at least one of said layers comprising a substantially opaque layer;
a decorative component incorporated into at least one of said top and backer layers; and
at least one of a heat embossing component and a CNC operated mechanical router for defining, upon said co-extruded article in a material removal operation, a series of interconnecting grout lines, between which are defined individual tiles.

9. The system as described in claim 8, further comprising said top layer applied by at least one of a secondary extruding and a co-laminating application.

10. The system as described in claim 8, said top layer having a specified shape and size and at least one layer being substantially transparent.

11. The system as described in claim 8, further comprising a razor knife for trimming an edge associated with said article.

12. The system as described in claim 7, further comprising a decorative particulate incorporated into at least one of said top and adhering backer layers.

13. A method for creating a three-dimensional resin based article exhibiting a faux tile board appearance, comprising:
forming an article having at least a top layer and an adhering backer layer, collectively exhibiting a specified length, width and thickness;
introducing a decorative component into at least one of said interconnected layers;
embossing an upper surface in order to replicate a series of interconnecting grout lines, between which are defined individual tiles; and
applying said article to any substantially rigid substratum material.

14. The method as described in claim 13, further comprising the step of co-extruding said article from a thermoformable resin.

15. The method as described in claim 13, further comprising the step of co-laminating said article from at least one of a thermoformable resin, a thermosetting resin, and a cellulosic layer.

16. The method as described in claim 13, further comprising the step of applying a durable and substantially clear/high gloss overlaying surface upon said article and prior to said step of embossing.

17. The method as described in claim 13, further comprising the step of introducing at least one of a polyolefin material, an ABS/Acrylic material, a cellulosic material, a thermoset material, into said formed article.

18. The method as described in claim 13, said step of embossing further comprising a routing tool applied to said upper surface of said formed article and in order to define a matte roughened finish corresponding to said faux replicated grout lines.

19. The method as described in claim 13, said step of replicating said grout lines further comprising heat embossing said article.

20. The method as described in claim 13, further comprising the step of applying a razor knife to trim a thermoformable edge associated with said article.

21. The method as described in claim 13, further comprising the step of introducing a decorative component into said article mimicking at least one of a metallic, glass, graphic or stone appearance.

22. The method as described in claim 21, further comprising the step of said backer layer exhibiting a substantially opaque appearance, said top layer further exhibiting at least a partially opaque appearance and further including a decorative particulate exhibiting an index-of-refraction matching material with a mean size distribution of less than 0.008″ therein.

23. The method as described in claim 13, further comprising the step of embossing a plurality of rounded edges established between said tiles and grout lines.
